(19) United States
(12) Patent Application Publication
(10) Pub. No.: US 2007/0292145 A1
(43) Pub. Date: Dec. 20, 2007

(54) SERVICES MANAGEMENT SYSTEM FOR EQUIPMENT

(76) Inventors: Jack S. Drose, Denver, CO (US); James A. Taylor, Houston, TX (US); Mark T. Lessner, Highlands Ranch, CO (US)

Correspondence Address: SHERIDAN ROSS PC, 1560 BROADWAY, SUITE 1200, DENVER, CO, 80202, US

(21) Appl. No.: 11/765,425

(22) Filed: Jun. 19, 2007

Related U.S. Application Data
(60) Provisional application No. 60/815,038, filed on Jun. 19, 2006.

(51) Int. Cl. G03G 15/00

(52) U.S. Cl. 399/8; 399/9

(57) ABSTRACT

An equipment maintenance and monitoring system and method is disclosed for, e.g., efficiently performing servicing and parts replacement in such equipment and thereby reducing service calls. In particular, the equipment maintenance and monitoring system and method preemptively prevents certain equipment failures by performing servicing and/or parts replacement on such equipment according to various predictive reliability indexes for measuring the reliability or unlikeliness of failing such equipment and parts therein. The equipment maintenance and monitoring system and method is further directed to efficiently performing servicing and parts replacement for printers, copiers, facsimile machines, scanners, optical character recognition scanners, plotters, and other devices as disclosed herein.

The present application claims the benefit of U.S. Provisional Patent Application No. 60/815,038 filed Jun. 19, 2006.

### RELATED FIELD OF THE INVENTION

The present application is directed to an equipment maintenance and monitoring system and method for, e.g., efficiently performing servicing and parts replacement in such equipment and thereby reducing service calls. In particular, the equipment maintenance and monitoring system and method preemptively prevents certain equipment failures by performing servicing and/or parts replacement on such equipment according to various predictive reliability indexes for measuring the reliability or unlikeliness of failing such equipment and parts therein. More particularly, the present equipment maintenance and monitoring system and method is directed to efficiently performing servicing and parts replacement for printers, copiers, facsimile machines, scanners, optical character recognition scanners, plotters, and other devices as disclosed herein.

### BACKGROUND

Printers and copiers are complex equipment generally requiring more servicing and maintenance than many other types of office equipment. Moreover, since printers/copiers can be expensive (both in price as well as maintenance and servicing), it is not uncommon for a business to lease at least some of their printers/copiers, and/or to outsource maintenance and servicing of their printers/copiers. Compensation to a dealer for a leased printer/copier may be based on the number copies made in a particular time period, and/or repair of maintenance of such printers and copiers under warranty or outside of any manufacturers warranty. For such leases, the dealer must obtain periodic meter readings indicating the number of copies provided by each leased printer/copier as well as monitor the service state of each such leased printer/copier. Additionally, when a dealer is to provide maintenance and servicing, the dealer must arrange to have printer/copier service personnel and parts at the business's site in a timely manner. However, dealers may find it difficult to manage and cost effectively maintain their installed based of printers/copiers, particularly, if the installed base is scattered over a relatively large geographical area such as a state or large metropolitan area.

Accordingly, automating the management of a dealer's contractual obligations for each of the dealer's licensed printers/copiers, and automating the collection of meter data indicating the number of copies made with each of the dealer's licensed printers/copiers as well as monitoring the service state of each such leased printer/copier can be of substantial benefit to a dealer as well as the users leasing the printer/copiers.

### SUMMARY

The present disclosure describes a management system (both method thereof and corresponding apparatus) for assisting in the management of equipment, and in particular the monitoring and maintenance of complex equipment such as printers, copiers, facsimile machines, scanners, optical character recognition scanners, plotters, and other equipment that satisfy at least some of the following characteristics: (i) can be linked via a communications network, (ii) requires sufficiently periodic or frequent servicing by trained technicians to warrant service contracts to cover such servicing, (iii) may require frequent service calls during operation, and/or (iv) have their operational status remotely monitored remotely. The management system provides services to equipment suppliers who, e.g., prefer not to service the equipment themselves that they sell or lease. For example, for a printer/copier dealer's installed base of printers/copiers, the present management system can be configured to manage, monitor, and schedule servicing on the dealer's installed base of printers/copiers according to business rules designated by the dealer. In particular, the management system disclosed herein provides: (1) such dealers with use data (e.g., usage data and/or meter data herein) for both networked and non-networked equipment (e.g., printers/copiers) upon which a dealer's leasing and/or service payments are at least partially based, and (2) notifications of service and/or parts required to maintain their installed of equipment. Additionally, the present management system is substantially automated, wherein for each of a plurality of equipment dealers, the present management system:
(a) receives such usage data, and notifications via network (e.g., Internet) transmissions from a plurality equipment sites for a plurality of dealers,
(b) provides each dealer with information regarding the receipt (or non-receipt) of usage data for equipment, wherein the dealer and the customers for such equipment have a contractual agreement regarding servicing and/or payment for use of the equipment,
(c) decodes equipment operational notifications from the various equipment specific operation notification formats, and analyzes such notifications for determining an appropriate response according to the responsible dealer's contractual obligations for maintaining the equipment leased or sold by the dealer, wherein the dealer can designate how parts and/or service for such equipment should be provided to such equipment, e.g., sold or leased by the dealer,
(d) predicts from such notifications when the equipment providing such notifications is likely to require parts and/or servicing, and predictively indicates and/or schedules when parts and service are to be provided to the equipment.

The present management system also provides equipment manufacturers and parts manufacturers, as well as equipment and parts resellers, with statistically relevant reliability data on the equipment and/or parts they produce so that under performing products can be identified and/or such reliability data can be used in promotions or advertising.

Other features and benefits of the present invention will become evident from the description hereinbelow together with the accompanying figures.

### BRIEF DESCRIPTION OF THE FIGURES

FIG. 1 shows a high level block diagram of an embodiment of the above-described management system for managing the maintenance, parts, and servicing of, e.g., printers, copiers, facsimile machines, scanners, optical character recognition scanners, plotters, and other equipment. The management system is referred to herein as a printer services management system 20.

FIG. 2 is a flowchart illustrating the high level processing steps performed by the printer management system 20 of FIG. 1.

FIG. 3 is a flowchart illustrating the high level processing steps performed by the message contents processor 114.

### DETAILED DESCRIPTION

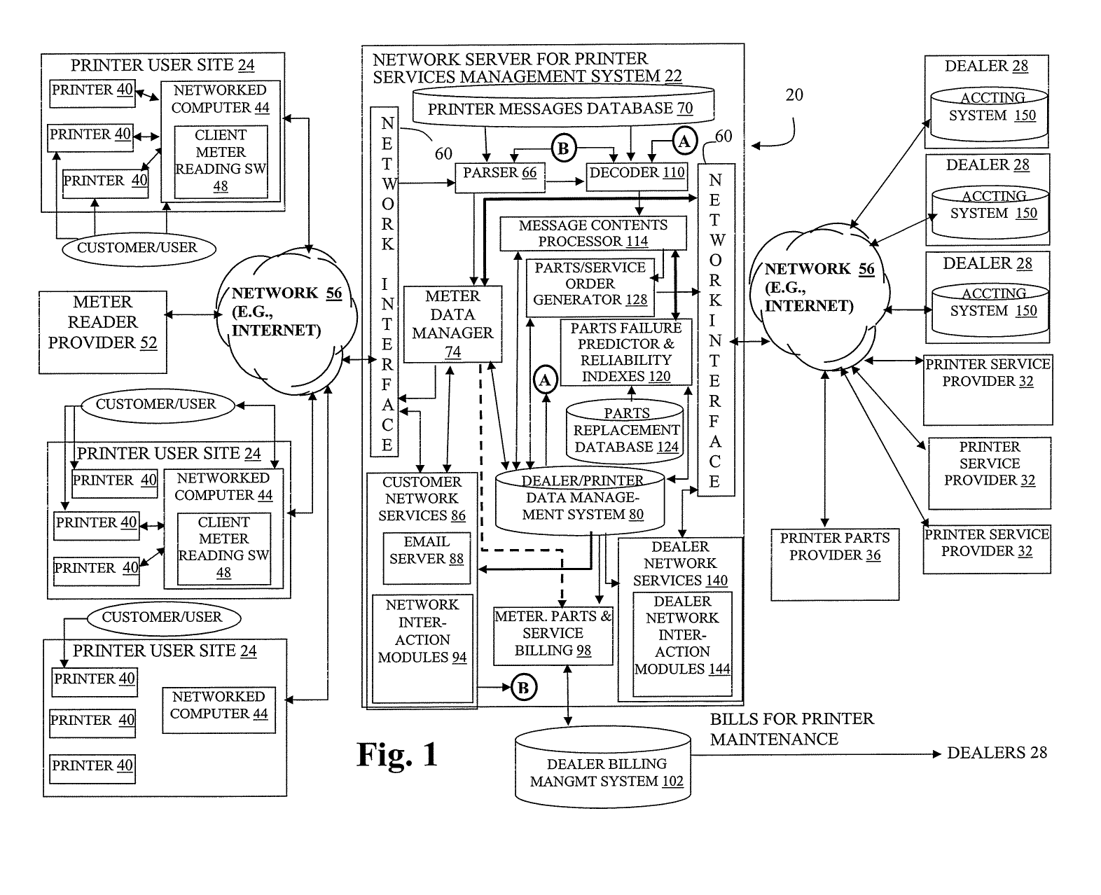

An embodiment of the printer services management system 20 is shown in FIG. 1 in an operational context, wherein there are network communications between printer user sites 24 and a management system network server 22, and between the management system network server 22 and various entities such as: printer/copier dealers 28, printer/copier service providers 32, and/or printer/copier parts provider(s) 36.

Each printer user site 24 includes:
(a) One or more printers/copiers 40, also herein simply referred to by the term “printers 40”, wherein it is understood that such terms also refer to printers, copiers, facsimile machines, scanners, optical character recognition scanners, plotters, and other devices wherein both a plurality of device purchasers/lessees, and their device suppliers prefer not to service the devices themselves, and additionally such devices satisfy at least some of the following characteristics: (i) can be linked via a communications network, (ii) requires sufficiently periodic or frequent servicing by trained technicians to warrant service contracts to cover such servicing, (iii) may require frequent service calls during operation, and/or (iv) have their operational status remotely monitored remotely. Such printers 40 may be from various manufacturers, may use various printer/copier technologies, and may vary in their makes and models. For example, one printer 40 may be a Hewlett Packard® laser printer with scanning and collating features, and another printer 40 may be a Nokia ink jet printer, while still another printer 40 may be a high speed Xerox® color printer.
(b) For some user sites 24, at least some of the printers 40 at the site may be in communication with a networked computer 44 for communicating use or meter data as well as printer operational notifications to the networked computer 44 so that this computer can then forward such information to the server 22 for processing as described hereinbelow.
(c) The networked computer 44 may include client meter reading software 48 for, e.g., querying the printers 40 identified to the client meter reading software that are in communication with the networked computer. In particular, meter reading software 48 queries each of the printers 40 (e.g., at the same site 24 and with which the computer 44 can communicate via, e.g., a local area network) for use data (i.e. meter data) indicating the number of copies that have been produced by the printer.

In one embodiment, there may be meter reader provider 52 distinct from the management system network server 22 for obtaining meter data from various printers 40 that are operably connected to the network 56 (e.g., the Internet) via a corresponding networked computer 44. In particular, the meter reader provider 52 performs the following operations: (a) monitors networked printers 40 for service events, (b) retrieves meter data based on a date established by the printer services management system 22, and (c) provides, in some embodiments, printer 40 parts requests to the management system 22, e.g., based on printer part catalogs provided to meter reader provider 52 by the printer services management system 22. In another embodiment, the network server 22 may also provide the functionality of the meter reader provider.

Components of the Printer Services Management System 22

The management system network server 22 includes the high level components identified and described in sections following.

Network interfaces 60

The network interfaces 60 receives and transmits communications on the network 56. Such a network 56 may be the Internet, an enterprise wide area network, and/or a local area network.

Parser 66

The parser 66 receives and identifies meter data and/or notifications indicative of the operational status of printers 40 (e.g., notifications of printer failures, reduced performance, over heating, excessive paper jams, etc.). The parser 66 receives such printer 40 related communications from the network 56 (via the network interface 60). In at least some embodiments, such a communication can include an identification of not only the printer 40, but also information identifying the corresponding user (e.g., customer) that has leased the printer 40, the user site 24 having the printer 40, and/or the dealer 28 for the printer. The input communications received by the parser 66 can be in various formats, e.g., printer operational status notifications may vary depending upon the make and model of the printers 40. Such communications may also contain meter data from the meter reader provider 52, or part request messages transmitted by one of the networked computers 44. Upon receiving such a communication,
(1) The parser 66 first identifies the type of communication received, such as whether the communication provides meter data, a notification of a printer 40 operational status, or a part/service request generated by a person. Such a determination may be determined by, e.g., examining a message header or descriptor provided in the communication and identifying data therein as a source of the communication, and data therein indicating the format of the remainder of the communication.
(2) If the parser 66 determines that such a communication includes meter data, then the parser parses the portions of the communication for identifying the data fields for: (a-i) the meter data, (a-ii) the printer 40 to which the meter data corresponds, (a-iii) the user site 40 of the printer 40, and (a-iv) (if provided) the dealer 28. Subsequently, the parser 66 passes data items (a-i) through (a-iv) to the meter data manager 74 which associates the meter data with the corresponding dealer 28 as described further hereinbelow.
(3) Alternatively, if the parser 66 determines that an input communication is a request for a part/service generated by a person, then the parser 66 parses the communication to identify the data fields for: (b-i) the part/service requested, (b-ii) the printer 40 to which the part request corresponds, (b-iii) the user site 40 of the printer 40, and (b-iv) (if provided) the dealer 28. Subsequently, the parser 66 passes data items (b-i) through (b-iv) to the parts/service processor 114 via the decoder 110 as described hereinbelow.
(4) Alternatively, if the parser 66 determines that an input communication is a notification of a printer 40 operational status, then the parser may require additional information in that such a communication may include at least a portion generated by the printer 40 to which the communication applies, and accordingly, the data format of this portion may be specific to a particular printer/copier manufacturer (and/or printer/copier model as well). The parser 66 may access the printer messages database 70 for obtaining a data format for the communication that is, e.g., specific to the printer 40 to which the communication applies. Subsequently, upon receiving data format information from the messages database 70, the parser 66 parses the communication for identifying the data fields for: (c-i) the data fields identifying the printer 40 operational status, (c-ii) the printer 40 to which the notification corresponds, (c-iii) the user site 40 of the printer 40, (c-iv) any customer error description, (c-v) any error code(s), (c-vi) priority code(s) indicative of the severity of the error, and (c-vii) (if provided) the dealer 28. Subsequently, the parser 66 passes data items (c-i) through (c-vii) to the decoder 110 described hereinbelow.
   Printer Messages Database 70

The printer messages database 70 includes data for each printer 40 manufacturer and model. In particular, for each printer 40, such data may include (and the database 70 associate): the printer's manufacturer and model, the format of operational messages generated by the printer 40, and translations of operational codes for the printer, wherein these codes identify an operational status of the printer 40 (e.g., low on toner, printer element inoperable, fan inoperative, etc.). Note that the printer messages database 70 associates such manufacturer operational codes with corresponding equivalents of a common (preferably easily understood) representation regardless of the printer 40 manufacturer and model. For example, one such a common representation may be natural language (e.g., English, Spanish, French, etc.) text. Thus, regardless of a printer 40 manufacturer and model, an operational code (e.g., “09”) for the printer indicating image defects may be associated with the text “image defects detected”.

Meter Data Manager 74

The meter data manager 74 receives usage or meter data transmitted from, e.g., a meter reader provider 52 and the network interaction modules 94 (described hereinbelow). For the printer 40 identified by the meter data received, the meter data manager 74 accumulates and time stamps such printer (more generally, equipment) usage data (e.g., including the number of printed pages for a copier, printer, etc.) so that the meter data can be correlated with its corresponding time period, and in particular, meter data manager 74 determines the usage information (e.g., the number of copies) produced by the printer 40 since the previous meter data was received. Note that multi-purpose equipment such as devices that, e.g. print, copy, scan with both in black and white, and color, the meter data may include separate usage information indicating the number of copies of each type that the printer 40 is able to produce. To determine the number of each type of copy produced (e.g., black and white, or color), the meter data manager 74 accesses the dealer/printer data management system 80 (described hereinbelow) for retrieving the (any) previous meter data. The meter data manager 74 then enters into the dealer/printer data management system 80 both: (a) the newly obtained meter data, and (b) for each copy type, the number of the copies, wherein both (a) and (b) data entries are also associated with data identifying the printer 40, and with the dealer 28 for this printer. In one embodiment, the meter data manager 74 may access information in the dealer/printer data management system 80 for identifying meter data that has not been received and is overdue, and for generating overdue notifications to, e.g., the meter reader provider 52 and/or a person at the user site 24 having the printer 40 whose meter data is overdue. Additional description of the processing performed by the meter data manager 74 is provided in the pseudo-code entitled: “Meter Data Manager 74 Processing” in the Appendix hereinbelow.

Dealer/Printer Data Management System 80

The dealer/printer data management system 80 stores and provides appropriate access to at least the following:
(i) For each dealer 28: the dealer's contact information, billing information, identification of the printers 40 for which the dealer is responsible, the current licensing contracts between the dealer and the dealer's customers.
(ii) For each printer 40: the manufacturer and model of the printer, identification of the dealer 28 responsible for the printer, information specifying the dealer's obligations under the current licensing contract for the printer (e.g., service response time constraints, whether customer or dealer pays for service and/or parts, etc.), information for determining dates for expected receipt of meter data (e.g., an initial date for receiving meter data, and an interval for periodically receiving meter data), information indicating to what extent the dealer 28 is to participate in servicing and/or providing parts for the printer (e.g., the dealer may specify one of: “Dealer Does All Service”, “Dealer Contacted First For All Service”, “Dealer Does No Service”, “Dealer Provides All Parts”, “Contact Dealer First For Parts”, “Dealer Provides No Parts”, see the pseudo code fragment “Parts/Service Order Generator Processing” hereinbelow).
(iii) For each printer 40, a history of its meter data, including for each meter reading, the date of the reading.
(iv) Additionally, in one embodiment, the dealer/printer data management system 80 also includes: service performance and/or information on the reliability of printer technicians used in maintaining the printers 40. In one embodiment, dealers 28 may also be rated according to their responsiveness in servicing the printers 40 for which they are responsible.
   Customer Network Services 86

The customer network services module 86 provides network (Internet) 56 communications between the printer services management system 22 and customers who have licensed at least one printer 40 from a dealer 28. In particular, such a customer network services module 86 may include: interactive presentations (web pages) wherein such presentations allow a customer to enter meter data, data regarding printer 40 malfunctions, complaints, printer 40 change of location, requests for printer 40 service and/or service, etc. Note that the customer network services 86 may include email services, via the email server 88, and network interaction modules 94, wherein these modules provide interactive presentations (e.g., web pages) for:
(i) authenticating a user requesting to input meter data for one or more printers 40, and/or provide requests for printer parts or service,
(ii) determining and/or verifying the identity of the printers 40 for which the user can legitimately provide such input,
(iii) receiving such inputs, and in particular meter data,
(iv) in some embodiments, performing checks on the likeliness or reasonableness of the input being correct/accurate, e.g., for input meter data, if upon comparing such data with previous meter data, it is determined that there is a substantially reduced (or a negative) number of copies produced from a particular printer 40, then presumably the meter data is incorrect; in particular, if, e.g., parts or service records indicates that the printer 40 has received substantial use in the recent metered time interval. Such checks may also be performed for parts and/or service requests received, e.g., via the customer network service module 86. For example, a service/part request that is determined to be likely a duplicate of a currently pending service/part request may result in the user being informed that the current service/part request is apparently a duplicate request, and accordingly the request will not be entered without the user contacting customer support for the service management system 22. In another example, if a user requests a certain part(s) at a frequency rate that is determined to be disproportionate to the use determined from the meter data, then the customer network services 86 may also refer the user to customer support and/or the responsible dealer 28 instead of entering an order for the part(s).

A high level description of the above functionality of the customer network services module 86 is provided by the pseudo-code entitled “Meter Reading From Contact Person At Customer Site 24” in the Appendix hereinbelow.

Additionally, the customer network services 86 may contact a printer customer/user 24 with notifications related to printer parts ordered and/or for scheduling printer servicing. Moreover, a customer/user may be able to view a status of a scheduled service (e.g., when it is to be performed), and to request rescheduling of such service via the customer network services 86. The status for such service may be presented/available to the customer/user for identifying one of the following: (a) when a service response entity (i.e., dealer 28, printer service provider 32, or printer parts provider 36) has been notified, e.g., the status may be identified as “responsive party notified”, (b) when a technician is scheduled for dispatch to the site 24 of the printer needing maintenance, the status may be changed to “service scheduled”, (c) when a technician is dispatched to the site 24 of the printer needing maintenance, the status may be changed to “service technician in route”, (d) when the service is completed and the printer is operating as desired, the status may be changed to “service completed”, (e) when the service is performed, but additional service and/or a part(s) is additionally needed, the status may be changed to “to additional service required”.

Note that in at least one embodiment, much of the functionality of the decoder 110 described hereinbelow may be also provided by the computer network services module 86. For instance, the module 86 may determine from the customer input:
(i) the identity of the printer(s) 40 to which the input is directed,
(ii) the identity of printer manufacturer(s) and model(s) by accessing the dealer/printer data management system 80, and/or
(iii) one or more common representations for a customer input printer 40 operational status for the identified printer(s) 40, e.g., common representations of such printer operational statuses as: a printer failure, a reduced printer performance, an over heating of a printer, excessive printer paper jams, etc.). Note that a customer input may include printer specific operational codes, and/or more generic descriptions of a printer operational status. In at least the case where the customer inputs printer specific operational messages, the customer input may be provided to the printer messages database 70 for decoding.
(iv) Service call history per printer 40, per user site 24, and/or per dealer 28.
   Meter, Parts and Service Billing 98

The meter, parts and service billing module 98 computes, for each dealer 28, an amount to be collected from each of the dealer's customers for copies produced on the customer's printer(s) 40. Thus, the module 98 may receive copy amounts directly from the meter data manager 74. However, in one embodiment, the meter data manager 74 outputs such copy amounts for storing in the dealer/printer data management system 80, and the present module 98 accesses such information from the data management system 80. Note that the data management system 80 may output a message to the present module 98 that such copy amounts are available. Further note that since there may be different licensing contracts between a dealer 28 and different customers for the dealer, the present module 98 accesses the dealer/printer data management system 80 for accessing, e.g., a formula or programmatic element(s) for computing customer copy charges as specified in the corresponding licensing contract for the customer's printers 40. Note that such formulas or programmatic element(s) may compute copy charges for a given billing cycle according to various thresholds for the total number of copies produced by one or more printers 40 (e.g., the price per copy may vary depending on the total number of copies produced on the one or more printers 40 individually or aggregately). Thus, a first price per copy may specified for copies below 50,000 and another price per copy may specified for copies greater than 50,000.

Additionally, the present module 98 also generates billing data for billing each dealer 28 for the parts and/or services provided for the printers 40 for which the dealer is responsible. Accordingly, the module 98 may access the data management system 80 for obtaining records of parts and/or services performed on behalf of a dealer 28 by, e.g., a printer service provider 32 or a printer parts provider 36 in a most recent billing interval.

The module 98 outputs resulting billing data for each dealer 28 to a dealer billing management system 102 as described hereinbelow.

Dealer Billing Management System 102

The dealer billing management system 102 generates invoices to the dealers 28. The dealer billing management system 102 performs typical billing functions such as generating dealer invoices providing totals of all current and past due amounts, computing late payment fees, generating notifications to printer services management system 22 personnel of dealers 28 whose accounts are substantially in arrears, etc. Additionally, the dealer billing management system 102 may also provide each dealer 28 with amounts the dealer should charge its customers for printer 40 copy charges, and/or with amounts the dealer should charge for any parts or service (or portion thereof) to be charged back to the dealer's customers (as per the dealer's printer licensing contracts). In one embodiment, such customer charges may be generated as separate invoices for each of the dealer's customers, and sent directly to the customers (with, e.g., an electronic copy of each such invoice being provided to the dealer).

Decoder 110

When necessary, the decoder 110 converts printer manufacturer operational codes output by the parser 66 into a common preferably easily understood representation (e.g., natural language text). In decoding or translating printer operational status message fields, the decoder 110:
(i) First determines the identity of the printer 40 (e.g., a serial number) from the parsed fields identified by the parser 66.
(ii) Then the decoder 110 accesses the dealer/printer data management system 80 (using the printer identity) for identifying the manufacturer and model of the printer 40.
(iii) Subsequently, the decoder 110 inputs the identity of the manufacturer and model of the printer 40 to the printer messages database 70 together with the one or more operational status codes from the notification received from the printer for thereby obtaining the corresponding one or more common representations of the operational status codes, wherein such representations are common or generic across printer manufacturers and models. Note that such common representations includes an identification of the type of notification received by the network server 22. In particular, the following notification types are available:
   Routine Notification, wherein no replacement parts or service is likely necessary; e.g., such a notification may be for printer 40 conditions such as: printer out of paper, paper jam, printer reset, etc,
   Failure Notification, wherein the printer 40 is malfunctioning and thus requires a part and/or servicing,
   Eminent Failure Notification, wherein this notification identifies at least one of: a part that has not malfunctioned, but in the near future will or is likely to fail unless the part is replaced, and/or the printer 40 is serviced in a timely manner, and in particular, such replacement and/or servicing being prior to failure of the part.
Additionally, in some embodiments there may be at least one additionally notification received by the management system 22 for indicating that a normal or scheduled service event should be performed on a particular printer 40. However, such notifications are not described herein since the dealer/printer data management system 80 may include data for automatically identifying when such normal or scheduled service events are to be performed. In particular, the management system 80 may include database triggers for activating the part/service order generator 128 (described hereinbelow) to output a service order for such normal or scheduled database
(iv) Finally, the decoder 110 outputs: the printer identity, the make and model of the printer, and the decoded operational status codes to the message contents processor 114. Note, that this output may include an identification field for identifying the type of notification the decoder 110 received. Additionally, note that any other fields identified by the parser 66 are also output to the message contents processor 114 as well. Thus, the following data fields (if available) may be also output by the decoder 110: the printer 40 location, the dealer 28 identification for the printer, any priority code corresponding to the printer notification, any error code(s) identified in the operational status(es), etc.

Once the decoding or translating of the printer operational status message fields is complete, the decoder 110 outputs such information together with data identifying the printer 40 (e.g., its make, model, site 24 location, lessee/owner, and any responsible dealer 28) to the message contents processor 114 described hereinbelow.

Note that a similar procedure as to the steps (i) through (iv) above may be performed when the parser 66 receives an input generated by a person, e.g., at a user site 24.

Message Contents Processor 114

The message contents processor 114, upon receiving input from the decoder 110 as described hereinabove, determines whether and/or what service and/or parts are to be provided to a printer 40 identified by a communication regarding an expected or actual malfunction of the printer. Additionally, the message contents processor 114 activates the parts/service order generator 128 (described hereinbelow) for generating (if necessary) one or more orders for service and/or parts for the printer. Additional description of the processing performed by the message contents processor 114 is provided by the pseudo-code fragment “Message Contents Processor 114 (Notification)” in the Appendix hereinbelow, wherein this pseudo-code fragment is for a single operational status notification identified as “Notification”. However, it is within the scope of the present disclosure that multiple operational status notifications may be processed concurrently and/or within a relatively short period of time so that, e.g., in the event that multiple malfunctions of a printer 40 occurred within a period of time prior to a particular servicing of the printer, then each (or at least most) of these malfunctions will be addressed in a single service appointment.

Parts Failure Predictor & Reliability Indices 120

The parts failure predictor & reliability indices module 120 determines the following:
(1) An expected failure date(s) of a printer 40 and/or a part for a printer 40, which in one embodiment is described in the Appendix by the pseudo-code fragments entitled: “Predict Estimate Failure Date &Usage(Notification, PRINTER_RELIABILITY)”, “Predict Likely Failure Items(Notification, PRINTER_RELIABILITY)”, and “Predict date & meter reading of failure of the part(Item_Id, Notification)”;
(2) At least two reliability indexes, i.e., a printer/copier reliability index for indicating or predicting a likely future reliability of a printer 40, e.g., in comparison to other printers/copiers, and a part reliability index (also referred to herein as an “item reliability index”) for indicating or predicting a likely future reliability of a printer 40 part, e.g., in comparison to other parts. In particular, the higher the value of such an index the more reliable the printer or part is, and correspondingly the fewer failures have occurred, e.g., relative to other similar devices and/or similar parts. Embodiments of functions for computing these two indexes described in the Appendix by the pseudo-code fragments entitled: “Printer Reliability Index(Printer_Id)”, and “Item Reliability Index(Item_Id)”. Note that these two indexes are used in computing the expected failure date(s) of (1) immediately above.

The computed values of (1) and (2) immediately above may be used to determine when it is more cost effective to replace a printer 40 than to continue to service the printer, or may be used to determine when it is more cost effective to pre-emptively and proactively perform maintenance on a printer 40 to increase the printer's subsequent reliability (e.g., reduce the number of subsequent service calls on the printer). The values computed in (1) and (2) above may be used as follows. When a message originating from a target printer 40 (or a printer 40 user/customer) is received at the printer services management system 22 indicating that the target printer 40 is likely to malfunction in the near future (e.g., the printer's toner cartridge is low on toner), the parts failure predictor & reliability indexes module 120 may compute an approximate date that the malfunction is likely to actually occur (e.g., when the toner will be entirely depleted), and thus output a date for servicing the target printer 40 (e.g., for replacing the toner cartridge prior to the printer failing). Additionally, such indexes can be determined for other purposes such as for viewing by an management system 20 operator when, e.g., service orders require manual input or review.

In one embodiment, the reliability measurements or indexes of (2) immediately above are computed when requested. In another embodiment, such indexes may be computed automatically as new pertinent data is obtained. For determining the printer/copier reliability index or measurement of the target printer 40, such a measurement of reliability may be determined as a function of an average utilization (of a printer) between failures (UBF) for each printer 40 in a selected population of printers 40. In one embodiment, the UBF for a given printer 40 can be the average number of copies or prints made between failures (or notifications of impending failure) of the given printer. In another embodiment, the UBF for a given printer 40 can be the average length of time that the given printer 40 is operational. Of course, additional alternative criteria can be used for determining the UBF. In the description hereinbelow the average number of copies or prints made between failures (or notifications of impending failure) of the given printer used; however, other definitions of UBF are within the scope of the present disclosure. Accordingly, the printer/copier reliability index or measurement may be obtained from comparing, or determining a deviation, between the average utilization between failure of the target printer 40, and such UBFs for other printers/copiers 40 from a particular population of printers/copiers such as, e.g., other printers/copiers at a given site 24, or other printers 40 that are identical or functionally similar to the target printer 40. Note, however, that other measurements of reliability are also within the scope of the present disclosure such as a cost adjusted reliability measurement, wherein the cost of each failure is determined, and such costs are summed for the target printer 40, and the sum is compared with corresponding summed costs for a particular population of printers/copiers.

Additionally, for determining a part reliability index or measurement of a part (the “target part”) installed in a particular printer 40, such a reliability measurement may be determined by determining an average utilization between failures (UBF) for all instances of the target part that have been installed in the particular printer 40, wherein the UBF for this target part can be computed similarly to the UBF for a printer 40 described hereinabove. In one embodiment, the metric used for determining the UBF for a target part installed in the particular printer 40 is the number of prints/copies made between failures (or notifications of impending failure) of the target part. However, other metrics can also be used, and in particular, the metrics identified above for determining UBFs for printers 40 may be used. Since corresponding UBFs can be computed for the same part in a selected population of printers 40 (or functionally corresponding parts in a selected population of printers 40), the target part's reliability index can be determined by comparing, or determining a deviation, between the UBF of the target part in the particular printer 40, and the UBFs of the same or corresponding parts installed in other printers/copiers from the selected population of printers/copiers. Note that the population of selected printers 40 can be, e.g., printers/copiers at a given site 24, or all printers/copiers 40 having an instance of the part installed therein. Other measurements of a part reliability are also within the scope of the present disclosure such as a cost adjusted reliability measurement, wherein the cost of each failure of target parts is determined within a first population of printers/copiers 40 (e.g., within a single printer/copier 40, or within the printers/copiers at a same site 24), and such costs are summed for the target part instances, and the sum is then compared, or a deviation is determined, between corresponding summed costs for another population of corresponding part instances installed in another selected population of printers 40 (e.g., a larger population of printers/copiers, or a population of printers/copiers 40 having parts similar to the target part, e.g., provided by a different manufacturer/supplier).

It has been found that the printer/copier reliability index for a particular printer 40 provides an indication as to whether the particular printer 40 should be replaced instead of repaired. For example, if the printer/copier reliability index indicates the particular printer 40 is substantially less reliable than corresponding printers 40, e.g., more than a standard deviation less reliable, then replacement may be considered. Moreover, it has been found that the part reliability index also provides an alternative indication as to whether a particular printer/copier should be replaced. For example, if the first population includes only the particular printer/copier 40, and the particular part is expensive and/or time consuming to replace, then even though the reliability index for the particular printer as a whole is acceptable, if the part reliability for the particular part indicates comparatively frequent replacement (i.e., low reliability), then replacement of the particular printer/copier should be considered. Additionally, the part reliability index can be used to compare the quality of parts received from two or more different manufacturers or suppliers. Moreover, the parts reliability index can also be used to evaluate similar parts across manufacturers and devices since many parts can be installed in devices of various manufacturers and/or in device models within a single manufacturers product line.

It is within the scope of the present disclosure that alterative/additional techniques for determining a measurement indicative of reliability of printers 40. In one embodiment, linear programming techniques may be used for identifying unreliable printers 40. In one embodiment, a learning or adaptive computational technique may be used, wherein, e.g., patterns of service calls and/or parts replaced on printers 40 identified as unreliable may be determined and such patterns may be used to identify or predict other printers 40 that fit such patterns. In one embodiment, variable statistical models may be used for identifying or predicting printers 40 that are unreliable (e.g., printers 40 for which it is more cost effective to replace them than to continue to service them, or it is more cost effective to preemptively perform maintenance on these printers to increase their subsequent reliability than to incur costs for repeated subsequent service calls).

An example of one embodiment of the printer/copier reliability index is as follows. The printer/equipment reliability index (ERI) can be expressed as the number of standard deviations from the average utilization between failures (UBF) value for a given printer 40, as compared to a given population of printers 40. In particular, a lower UBF value recorded for the given printer 40 indicates lower level of reliability with regard to its operation, and a higher UBF value implies a greater degree of reliability for the given printer and accordingly a lesser likelihood that the given printer will fail in comparison to the performance of its counterparts in the comparison population of printers/copiers. With this in mind, the ERI seeks to give an indication at a glance, of whether the given printer 40 is underperforming in relation to other printers/copiers, so that corrective action can be taken. As an illustration, consider the following scenario. Five printers 40 (identified as printers A, B, C, D, and E hereinbelow) are installed at a particular one of the sites 24. Assume that the ERI for printer A is to be determined, and that the given population of printers 40 to which printer A is to be compared is the collection of all printers A through E at the particular site 24. Further assume that the UBF values of the printers 40 at the particular site 24 can be expressed as the set {20,000 UBF (printer A), 55,000 UBF (printer B), 40,000 UBF (printer C), 65,000 UBF (printer D), 50,000 UBF (printer E)}. Using these assumptions and data, the ERI for printer A, can be calculated in three steps:
Step 1a: Calculate the average UBF value (AVG) for the given population of printers 40:
   AVG=1/5*(20,000 UBF+55,000 UBF+40,000 UBF+65,000 UBF+50,000 UBF)
   AVG=1/5* 230,000 UBF
   AVG=230,000/5 UBF
   AVG=46,000 UBF
Step 2a: Calculate the standard deviation (STDEV) from the average UBF value (AVG) for the given population of printers 40:
   STDEV=square root of (1/5*((20,000−46,000)²+(55,000−46,000)²+(40,000−46,000)²+(65,000−46,000)²+(50,000−46,000)²))
   STDEV=square root of (1/5*((−26,000)²+(9,000)²+(−6,000)²+(19,000)²+(4,000)²))
   STDEV=square root of (1/5*(676,000,000+81,000,000+36,000,000+361,000,000+16,000,000))
   STDEV=square root of (1/5*(1,170,000,000)
   STDEV=square root of (1,170,000,000/5)
   STDEV=square root of (234,000,000)
   STDEV=15,297.0585 UBF.
Step 3a: Calculate the printer reliability index (ERI_{A}) value for printer A, expressed as the difference between the printer A UBF value and the average UBF value (AVG) for the printers A through E, divided by the standard deviation value determined in Step 2a:
   ERI_{A}=(20,000 UBF−46,000 UBF)/15,297.0585 UBF
   ERI_{A}=−26,000 UBF/15,297.0585 UBF
   ERI_{A}=−1.6997.

The printer reliability index for printer A indicates that the UBF value recorded for this printer of 20,000 UBF, is 1.6997 times the standard deviation BELOW the average UBF value for the given population of printers at the particular site 24. This is one potential indicator of “unreliability,” in comparison to the other printers at the particular site 24.

Note, if it is assumed that printer A's potential for failure can be derived in probability theory from stochastic models based on the central limit theorem and the normal or “Gaussian” distribution, which suggest that sums of independent, identically-distributed random variables are normally distributed, then about 68% of the recorded UBF values for the printers A through E at the particular site 24 should be within one standard deviation of the average UBF value; about 95% of those UBF values should be within two standard deviations; and about 99.7% should be within three standard deviations of the average UBF value. Using these metrics, it may be concluded that any printer 40 at the particular site 24 showing an print reliability index value less than “−3”, i.e., three standard deviations BELOW the average UBF value may indicate an increased likelihood of unreliability and should be replaced. Printer A's ERI value may not be so far out of bounds as this, but the fact that is being outperformed by about 68% of the printers at the particular site 24 may be cause for concern.

In another embodiment, the printer reliability index (ERI) may be determined as follows: (total number of service calls from the particular printer/copier 40 per 1000 copies) divided by (the actual number of service calls logged from all printers/copiers 40 of the same make and model per 1000 copies). Note, this ratio may be further modified so that it is applicable to a recent period of time or a recent number of prints made. Thus, the ratio may be for a most recent 12 month period, and/or for at least a most recent 50,000 copies for each printer/copier of the same make and model. The printer reliability index can also be used to compare the reliability of various makes and models of a single manufacturer, and/or compare the reliability of various makes and models of a plurality of different manufacturers.

Accordingly, in one embodiment of the present disclosure, prior to scheduling a service call (or notifying the responsible dealer 28) about a malfunctioning printer 40 (or such a printer that is likely to malfunction in the near future), operators of the printer services management system 20 may view the printer reliability index for the malfunctioning printer 40 for: scheduling a replacement of the malfunctioning printer 40, and/or notifying the responsible dealer 28 of the unreliability of the malfunctioning printer so that this dealer can determine whether to replace the printer or not.

Regarding the part reliability index (PRI) for a particular target part in a particular printer 40, in one embodiment, the computations for this index are substantially identical to the Steps 1a through 3a illustrated hereinabove for the printer/copier reliability index. More precisely, instead of the “given population” being a population of printers 40 as in Steps 1a through 3a, the given population is now a collection of installed instances of the target part in a particular population of printers 40, and the average UBF is indicative of an average failure of the part instances failing in the particular population of printers 40. Accordingly, the PRI for a particular target part can be calculated via the following three steps 1b through 3b:
Step 1b: Calculate the average UBF value for the collection of target part instances (or equivalents thereof) installed in the chosen population of printers 40. Note, rather than the UBF of the printers 40 (as in Step 1a above), the present calculation is uses the UBFs for the target part instances (or equivalents thereof) installed in the printers 40 of the chosen population; other than this, the average calculation is performed as in Step 1a.
Step 2b: Calculate the standard deviation from the average UBF value for the collection of target part instances installed in the chosen population of printers 40. This calculation is identical to Step 2a, except the values for the UBFs and the number target part instance change to reflect the current situation.
Step 3b: Calculate the printer reliability index (PRI) value for the particular target part, wherein PRI is determined as the difference between the particular target part UBF value and the average UBF value for the part instances in the printers 40 of the chosen population, divided by the standard deviation value from Step 2b. This calculation is identical to Step 3a, except the values for the UBFs and the standard deviation value change to reflect the current situation.
   Accordingly, a negative value for PRI indicates that the particular target part of the particular printer 40 is less reliable than those target part instances in the chosen population of printers 40. In particular, discussion hereinabove regarding the interpretation of the printer reliability index is also applicable here to the part reliability index. Thus, a PRI value greater than −1.00 (i.e., the particular target part is no less reliable than the target part instances (or equivalents thereof) that are within one standard deviation of the average utilization between failures for these target part instances), would likely not be of concern. However, for a PRI of less than −3 one or more of the following may be inferred and/or acted upon:
(i) The printer/copier 40 having the particular target part may warrant replacement, particularly if this target part is expensive, e.g., 30% of the cost of the particular printer 40 containing it.
(ii) If all the replacements for the particular target part are from the same manufacturer, and all the replacements from the collection of target part instances (or equivalents thereof) in the chosen population of printers 40 are from other manufacturers, then the manufacturer of the particular target part may be supplying parts that are less reliable than other manufacturers.
(iii) If the particular target part has been replaced with parts deemed to be of comparable (or the same) reliability as those of the target part instances (or equivalents thereof) in the chosen population of printers 40, environmental conditions and/or how the particular printer 40 is being used may be affecting the reliability of the particular target part. Accordingly, a technician servicing the particular printer 40 may be instructed to inspect the environment surrounding this printer 40, and/or to investigate how this printer/copier is being used.

In another embodiment, the part reliability index may be determined for a printer item as follows: (the total number of service calls for servicing or replacing the printer item per 1000 copies) divided by (the actual number of service calls logged from all printers/copiers 40 having the same printer item, or equivalent thereof).

Further details describing the processing performed by the part failure predictor & reliability indices module 120 are provided by the pseudo-code fragments “Reliability Predictor 120 Processing(Notification)”, “Printer Reliability Index(Printer_Id)”, and “Item Reliability Index(Item_Id)” provided in the Appendix hereinbelow. In particular, note that there two embodiments described for each of the printer reliability index and the part reliability index, and that these embodiments are somewhat different from their corresponding embodiments hereinabove. In particular, each of the index computations in the Appendix are normalized to the range between 0 and 1.0. If desired, one of ordinary skill in the art will be able to properly normalize the printer and part index computations hereinabove, or adjust various threshold values in the printer and part index computations in the Appendix so that normalization is unnecessary.
Parts Replacement Database 124

The parts replacement database 124 maintains and provides appropriate access to an historical record for printer parts, wherein for each such part, the following data items may be available: the reliability of the printer part replacements, the usage histories (e.g., meter data) for the installed instances of the part, and the servicing performed on the part. Such historical record part information is used to determine a projected life expectancy of various printer parts, both printer consumable items (e.g., supplies and parts that are gradually and predictably consumed during the printing process), and printer non-consumable items (e.g., printer parts that may abruptly or unexpectedly malfunction). Note that both consumable and non-consumable items are referred to as “parts” herein. Replacement parts may be prioritized or rated based on a reliability index, as described in the Part Failure Predictor & Reliability Indices 120 section hereinabove. Once such reliability measurements are generated by the module 120, these measurement may be stored in the parts replacement database 124. Note that such reliability measurements may be associated for access by, e.g., make and model number of the printers that use the part, as well as the error codes that are indicative of the part failing (or likely to fail).

Note that for a consumable printer item (e.g., a printer 40 part that is predictably and gradually consumed during operation of its printer 40) the parts replacement database 124 may also store statistics indicative of an expected length of time prior to failure of the consumable printer item (from, e.g., a first notification related to such a failure), and such statistics are also computed by the module 120.

Parts/Service Order Generator 128

The parts/service order generator 128 generates both part and service orders for printers 40. The parts/service order generator 128 is activated by the message contents processor 114, and returns to the message contents processor 114 all part and service order data generated. In particular, if the parts/service order generator 128 may generate and return a date for the generated service order to be performed on a printer 40, wherein the date is expected Further description of an embodiment of the parts/service order generator 128 is provided in the pseudo-code entitled “Parts/Service Order Generator 128(NOTIFICATION, PRINTER_RELIABILITY, FULFILLMENT_DATE)” of the Appendix hereinbelow.

Dealer Network Services 140

The dealer network services 140 provides network 56 (e.g., Internet) communications between the printer services management system 22 and the dealers 28 who have at least one printer 40 managed by the management system 22. In particular, such dealer network services 140 may include: interactive presentations (web pages) wherein such presentations allow a dealer, for each of the dealer's printers 40: (i) to determine the meter data for the printer that has been obtained, (ii) to request generation and sending of an invoice for the meter data, wherein the invoice may be transmitted to both the dealer's accounting system 150, and the customer, (iii) to request that a communication be transmitted to the customer for the printer, wherein the communication requests that the customer manually transmit the printer's meter data, and/or (iv) to cancel one or more instances of the meter data for the printer. Additionally, in one embodiment, the dealer network services 140 may allow dealers 28 to view generated invoices for printer 40 parts and/or services performed on behalf of the dealers. In particular, the printer management system 22 may generate the following invoices for presentation to a dealer 28 via the network 56: an invoice to the dealer 28 for parts and services provided by a printer service provider 32 or a printer parts provider 36, and/or an invoice to be billed to one of the dealer's printer customers on behalf of the dealer. Note that the dealer network services 140 may include email services, via, e.g., the email server 88 and dealer network interaction modules 144, wherein these modules provide interactive presentations (e.g., web pages) for:
(a) authenticating a dealer 28 representative requesting to access the dealer's meter data, invoices, part/service notices (see the pseudo-code fragment for the parts/service order generator 128 hereinbelow), part/service orders generated and transmitted to various entities (e.g., to the dealer, to a printer service provider 32, and/or to a printer parts provider 36);
(b) determining and presenting dealer specific information related to the dealer; and
(c) receiving corresponding network inputs from the dealer.
   Dealer Network Interaction Modules 144

Various dealer 28 interaction modules 144 may be provided, such as:
(i) A module for registering a new dealer 28, and registering the new dealer's printer customers (e.g., the dealer's printer lessees). An embodiment of this module is provided by the pseudo-code entitled: “Registering A New Dealer 28 and the New Dealer's Printer Customers at User Sites 24” of the Appendix hereinbelow.
(ii) A module for preventing a dealer 28 from using the services of the printer services management system 20, and notifying the dealer's customer's that the services provided by the system 20 is being discontinued.
(iii) A module for preventing a printer customer and/or the printers 40 at a customer site 24 from using the printer management system 20.
(iv) A module for allowing a dealer to view the meter data obtained from the dealer's printer customers. In particular, a dealer 28 may view printer usage data derived from the meter data by customer, by site 24, and/or by printer 40.
   Operation of the Printer Services Management System 20

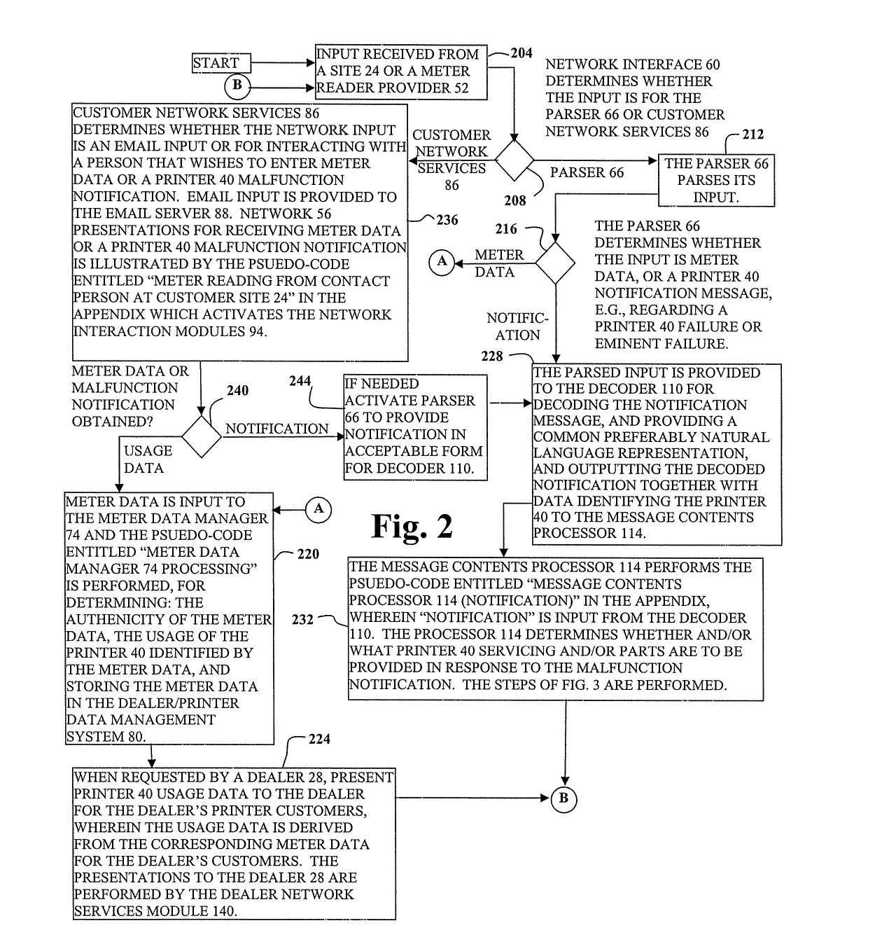

Assuming a dealer 28 and its printer 40 customers are registered with the printer services management system 20 (as, e.g., described in the pseudo-code entitled: “Registering A New Dealer 28 and the New Dealer's Printer Customers at User Sites 24” of the Appendix hereinbelow, FIG. 2 shows an illustrative flowchart of the processing performed by the printer services management system 20, and more particularly, the network server for printer services management 22, for processing network communications received from a printer user site 24 and/or a meter reader provider 52. In step 204, an input is received at the network interface 60 from one of a printer user site 24 and/or a meter reader provider 52 via the network 56 (e.g., the Internet or another network such as a local or wide area network). In step 208, a determination is made by the interface 60 as to whether the input is: (i) an automatically generated response, e.g., providing usage data (such as a meter reading data) or a printer 40 notification, or (ii) a user session for providing such information, albeit via an interactive online session with a user. Note that in one embodiment, the inputs of (i) and (ii) above are provided to different network 56 addresses associated with the network interface 60. Thus, the interface 60 readily distinguishes between these two inputs. If the input is according to (i) above, then this input is supplied to the parser 66, and in step 212, the parser 66 parses this input as described in the Parser 66 section hereinabove. Subsequently, in step 216, the parser 66 determines whether the parsed input is usage data, e.g., obtained from the meter reader provider 52, or a notification regarding the operational status of a printer 40.

The following pseudo-code fragments are illustrative of the steps 204 through 216, wherein the first pseudo-code fragment provides parsed usage data to the meter data manager 74, and the second pseudo-code fragment (entitled “Printer Service Processing In Response To A Printer Message”) provides notification/alert data to the decoder 110 as further described in step 228.

Pseudo-Code Fragments

```
Automated Meter Reading A Customer Site 24
    The network interface 60 receives, at a predetermined network address for the system 22,
        a network message from a user site 24 and/or a meter reader provider 52. Note
        the predetermined network address may be exclusively for receiving automated
        meter data;
    The network interface 60 inputs the network message to the parser 66 which attempts to
        parse the message;
    If the parser 66 is able to parse the message and identify it as meter data, then the parser
        66 creates a meter data record (REC) having the identification of the printer 40
        (P) for the meter data, an identification of the location of the printer P, and meter
        reading for the printer P;
    Activate the Meter Data Manager 74 Processing” pseudo-code as described below.
END.
Printer Service Processing In Response To A Printer Message
    The network interface 60 receives at a predetermined network address for the parser 66,
        a network message;
    The parser 66 attempts to parse the message;
    If the parser 66 is able to parse the message and identify it as a message from a printer 40
        (P), then the parser creates a notification/alert data record (REC) having the
        identification of the printer P, an identification of the location of the printer P,
        the contents (C) of the remainder of the message;
    The parser 66 then outputs REC to the decoder 110 for decoding the contents C, wherein
        the decoder uses the identification of the printer P to access the printer messages
        database 70 (if necessary) for decoding the contents C;
    The decoder 110 then outputs REC with the contents C decoded, to the message
        contents processor 114 for processing of the decoded contents C;
END.
```

If the parsed input is determined to be usage data (e.g., meter reading data), then step 220 is performed, wherein the parsed usage data is input to the meter data manager 74 as described in the Meter Data Manager 74 section hereinabove, and the pseudo-code entitled: “Meter Data Manager 74 Processing” of the Appendix hereinbelow. Note that authenticated usage data is stored in the deal/printer data management system 80, wherein such data is available for a dealers 28 to view via the network 56. In particular, as illustrated by step 224, when a registered dealer 28 logs on to the server 22 and is authenticated by the dealer network interaction modules 144, the dealer can request information related to the printers 40 which the dealer has installed at customer sites 24.

Following step 224, FIG. 2 shows the server 22 returning step 204 for receiving additional input from a printer user site 24 and/or a meter reader provider 52. However, typical embodiments of the server 22 are data driven, and the network interface 60 can receive such input at any time while the other components of the server 22 are processing, e.g., other such inputs. Thus, the flow of control arrow to “B” in FIG. 2 is merely representative of the current processing performed by the components of the server 22.

Returning now to step 216, if the parser 66 determines that the parsed input is a notification message, e.g., from a printer 40, then step 228 is performed, wherein the parsed input from the parser 66 is output to the decoder 110 for decoding. In particular, as described in the section titled: Decoder 110 hereinabove, the decoder 110 generates a common (preferably natural language) representation of the printer 40 related contents of the notification. Such common representations are generally not dependent upon the make and model of the printer 40 when the notifications are directed to similar functionality in printers 40 of different makes and/or models. For example, the printer 40 notification code for black ink being low in one inkjet printer 40 may be “0116BK”, and the printer 40 notification code for black ink being low in another inkjet printer 40 may be “56I1”. However, the decoder 110 outputs a common representation for both; e.g., “printer is black ink is low”. Note that the decoder 110 outputs a “Notification” data structure to the message contents processor 114, wherein the this data structure includes: the identity of the printer 40 identified by the input notification, an identification of the location or site 24 where the printer 40 is located, an identification of the dealer 28 from which the printer 40 was purchased/leased, the type of notification received (e.g., a routine notification, a failure notification, or an eminent failure notification), time and date the input notification was received by the network interface 66, what entity or user provided the input notification, and the common representation of the printer related contents of the input notification.

Step 232 of FIG. 2 illustrates the processing by the message contents processor 114. In particular, message contents processor 114 generates one or more service orders and/or dealer notifications for addressing operational malfunctions (or eminent malfunctions) of a printer 40 (P) identified by a corresponding notification received at the network interface 60. In generating such service orders and/or dealer notifications, the message contents processor 114 activates various functions of the parts failure predictor & reliability indexes module 120 for determining:
(i) A measurement indicative of the reliability of the printer 40 P. Computations for determining such a measurement are provided in pseudo-code titled “Printer Reliability Index(Printer_Id)” in the Append hereinbelow.
(ii) A measurement indicative of the reliability of a designated part installed in the printer 40 P. Computations for determining such measurement are provided in pseudo-code titled “Item Reliability Index(Item_Id)” in the Append hereinbelow.
(iii) An estimated earliest printer failure date and usage reading of a printer 40 P from which, e.g., a notification has received indicating that the printer P may fail in the near future. Computations for determining such failure dates and corresponding usage readings are provided in pseudo-code titled “Predict Estimate Failure Date & Usage(Notification, PRINTER_RELIABILITY)” in the Append hereinbelow.
(iv) A list of printer items (parts) that have failed in a printer 40 P or are likely to fail in the near future. Computations for determining such a list are provided in pseudo-code titled “Predict Likely Failure Items(Notification, PRINTER_RELIABILITY)” in the Append hereinbelow.
(v) An estimated and/or actual failure date and usage reading for a failure of a part in the printer 40 P from which, e.g., a notification has received indicating that the printer P may fail in the near future. Computations for determining such estimated and/or actual failure date and usage reading are provided in pseudo-code titled “Predict date & meter reading of failure of the part(Item_Id, Notification)” in the Append hereinbelow.

In generating the service orders and/or dealer 28 notifications, the message contents processor 114 activates the parts/service order generator 128 for generating the service orders and/or dealer notifications. In generating such service orders and/or dealer notifications, the parts/service order generator 128 determines to whom particular service orders are to be transmitted depending on designations by the dealer 28. For example, a dealer 28 has the option to have all service for printers 40 provided by the dealer to be automatically services by a third party. Additionally, the dealer 28 may request that all printer 40 parts for printers 40 provided by the dealer be supplied by a third party. Accordingly, the parts/service order generator 128 generates service orders for printer servicing and the parts needed in such servicing in accordance with business rules or data input by each of the dealers 28. Additional description of the parts/service order generator 128 is provided in the section hereinabove titled: “Parts/Service Order Generator 128”, and in the pseudo-code titled “Parts/Service Order Generator 128(NOTIFICATION, PRINTER_RELIABILITY, FULFILLMENT_DATE)” in the Append hereinbelow.

Following step 232, FIG. 2 shows the server 22 returning step 204 at “B” for receiving additional input from a printer user site 24 and/or a meter reader provider 52. However, as indicated previously typical embodiments of the server 22 are data driven, and the network interface 60 can receive such input at any time while the other components of the server 22 are processing, e.g., other such inputs. Thus, the flow of control arrow to “B” in FIG. 2 is merely representative of the current processing performed by the components of the server 22.

Returning now to step 208, in the event that the received input at network interface 60 is for a user to input of, e.g. printer 40 usage data and/or notifications related to the operational status of one or more printers 40, step 236 is performed, wherein the customer network services 86 determines whether the network 56 input is an email input or for a communication requesting an interactive network session. If email input is detected, then the input is provided to the email server 88. If a request for an interactive network session is detected for a user to input usage data and/or a notification related to the operational status of a printer 40, then one or more of the network interaction modules 94 are activated for, e.g., presenting forms to user in which the usage data and/or the notification can be entered. Subsequently, if an email was input, then an email automated reader, or a customer service representative determines whether the received email includes usage data (e.g., meter data), and/or notifications related to an operational status of a printer 40. Alternatively, if the network 56 customer input is form data from an online customer interaction session, then the network interaction modules 94 determine whether such input includes usage data (e.g., meter data), and/or notifications related to an operational status of a printer 40. Accordingly, in either case, step 240 is preformed for determining where to direct the input received. Accordingly, for a notification related to an operational status of a printer 40, step 244 may be performed for activating the parser 66 with the input. Note that activation of the parser 66 may not be necessary in some embodiments since the input already be properly parsed, e.g., due to menu selections for completing an online form. Subsequently, the steps 228 through 232 are performed as described hereinabove.

Returning now to step 240, if it is determined that usage data received, then steps 220 and 224 are performed as described hereinabove.

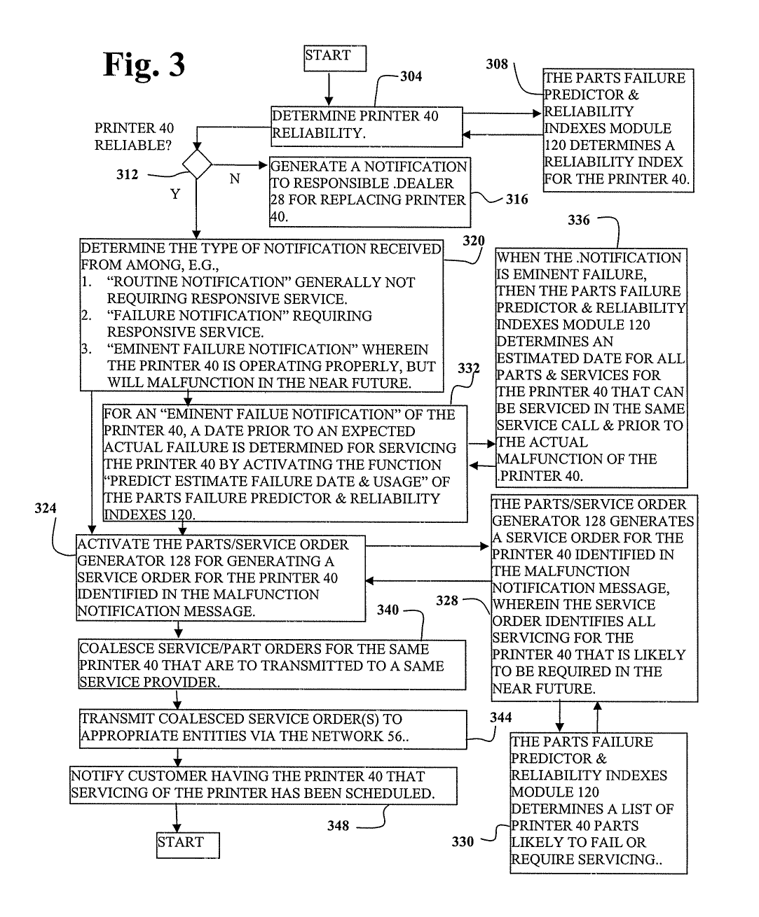

FIG. 3 shows flowchart of the high level steps of an embodiment of the message contents processor 114. It is assumed that a “Notification” data structure as described in step 228 of FIG. 2 hereinabove is input to the message contents processor 114. In step 304, a determination is made as to the reliability of the printer 40 identified in Notification by activating (in step 308) the function “Printer Reliability Index(Printer_Id)” of the Appendix hereinbelow. Subsequently, in step 312, a determination is made as to the whether the printer 40 identified in Notification is sufficiently reliable to warrant servicing. If not, then in step 316, a notification is generated (via activation of the parts/service order generator 128) for transmission to the dealer 28 indicating that the present printer 40 is unreliable and should be replaced with another printer 40. Alternatively, if the printer 40 is determined to be sufficiently reliable, then step 320 is performed, wherein a determination is made as to the type of notification received by the server 22 by examining the field, Notification.type. Note that there may be at least three different types of notifications as described as described, e.g., the section titled “Decoder 110” hereinabove. Subsequent processing of the notification depends on the type of the notification. For a routine notification, the only action performed may be the logging of the notification are determining a frequency of such notifications. For example, a notification of a paper jam may be classified as a routine notification. However, if the frequency of such jams, e.g., rises above a predetermined threshold, then servicing and/or inspection of the printer 40 may be scheduled. For a failure notification, it may be that the printer 40 has a service contract associated therewith which requires that that the printer be serviced in specific time period following notification of the printer failure. Accordingly, in step 324, the message contents processor 114 activates the parts/service order generator 128 for generating one or more service orders and part orders for servicing the printer 40 identified by Notification. Note that the parts/service order generator 128 preferably generates (in step 328) all service orders and part orders for all servicing of the printer 40 that is likely to be required in the near future. In performing this task, the parts/service order generator 128 activates the function “Predict Likely Failure Items(NOTIFICATION, PRINTER_RELIABILITY)” (in step 330) for determining all parts that are likely to fail, e.g., prior to a next regularly schedule servicing of the printer. Thus, regularly planned printer servicing may be moved up to an earlier date due to an unplanned service call for alleviating a malfunction of the printer. Additionally, parts installed in the printer may be replaced even though currently operating normally if it is determined that such parts are likely to failure, e.g., before a next regularly scheduled maintenance for servicing the printer.

If instead of the notification being a failure notification, the notification is for eminent failure, then step 332 is performed, wherein a printer servicing date is determined prior to an expected actual failure of the printer 40 identified by Notification. In determining such a servicing date, the message contents processor 114 activates (in step 336) the function “Predict Estimate Failure Date & Usage(Notification, PRINTER_RELIABILITY)” (as described in the Appendix) of the module 120 for determining a latest date when service can be performed and it is likely that the printer 40 will not fail or malfunction prior to this latest date. After step 332, is performed, step 324 is again performed.

Subsequently, regardless of how service and/or part orders are generated for printer 40 identified by Notification, when there are multiple orders for providing to the same entity (e.g., the dealer 28 for the printer 40, one of the printer service providers 32, or a printer parts provider 36), the message contents processor 114 (in step 340) may coalesce such orders and then transmit (in step 344) the coalesced order(s) to their designated entities. Note that since the part and printer servicing orders may be transmitted to different entities, the part orders may designate that the parts are to be delivered to the printer servicing entity. However, it is within the scope of the present disclosure that both part and serving orders are transmitted to the same entity such as the responsible dealer 28. Following step 344, the customer having the printer 40 to be serviced is notified that service has been scheduled on the printer 40 (in step 348).

The foregoing description together with the Appendix hereinbelow is presented for purposes of illustration and description. However, the description together with the Appendix hereinbelow is not intended to limit the invention to the form disclosed hereinabove. Consequently, variations and modifications commensurate with the teachings in the description together with the Appendix hereinbelow, within the skill and knowledge of the relevant art, are within the scope of the claims hereinbelow. The embodiments described hereinabove, together with the Appendix hereinbelow, are further intended to explain the best mode presently known of practicing the invention claimed hereinbelow, and to enable others of ordinary skill in the art to utilize the claimed invention in various embodiments, and with the various modifications required by their particular application or uses of the invention. Thus, it is intended that the appended claims hereinbelow be construed to include alternative embodiments to the extent permitted by the prior art.

What is claimed is:

1. A method for managing printers at a plurality of distributed sites, comprising:
receiving network communications for a plurality of printers, wherein the printers reside at sites distributed on the network, wherein each of the communications includes corresponding meter data indicative of a use of a corresponding one of the plurality of printers;
for each of the communications, perform the following steps:
(a) determining printer identification data of the corresponding printer;
(b) determining a customer for the corresponding printer;
(c) associating the corresponding meter data with the printer identification and the customer;
(d) storing status information that the corresponding meter data has been received;
for each printer provider of a plurality of printer providers, a step of providing the status information for each instance of the received meter data received from one of the printers (P), wherein the printer provider is contractually obligated to maintain the printer P in an operable condition;
identifying at least one of the plurality of printers wherein a corresponding instance of meter data for the at least one printer is overdue to be received in a network communication;
determining a network address of a contact for entering meter data for the at least one printer;
generating a network notification for sending to the contact at the network address a request for the instance of the meter data, wherein the notification includes a network address for receiving a response from the contact;
providing, to at least one of the printer providers, information as to whether one of the instances of the meter data is received for one of the printers (Q), wherein the at least one printer provider is contractually obligated to maintain the printer Q.

2. The method of claim 1, further including for each print (P) of at least some of the plurality of printers, the steps of:
receiving a network communication of an alert related to a servicing the printer P;
determining the printer identification of the printer P;
decoding, using the printer identification, the alert for obtaining a translation thereof;
identifying one of the printer service providers for servicing the printer P;
generating a service order for transmitting to the one printer service provider, wherein the service order includes the translation, and identifies the printer P, a location of the printer P, and the customer for the printer P.

3. The method of claim 2, wherein the alert includes a warning of diminished amount of a printing substance.

4. The method of claim 3, further including a step of predicting a time when the printer will malfunction due to a diminished amount of the printing substance.

5. The method of claim 4, wherein the predicting step includes using one or more instances of the corresponding meter data for the printer P for determining a service date for the service order.

6. A method for managing printers at a plurality of distributed sites, comprising:
receiving network communications for a plurality of printers, wherein the printers reside at sites distributed on the network, wherein the communications includes corresponding notification information related to an operational use of a corresponding one of the plurality of printers;
for each of notification (N) at least some of the notifications received, perform the following steps:
(a) decoding the notification N for determining data indicative of an operational condition of the corresponding printer for the notification N;
(b) predicting, using the data, at least one of a failure date and a failure meter reading for corresponding printer for the notification N;
(c) outputting information for servicing the corresponding printer for the notification N, wherein the output information is dependent upon the at least one of a failure date and a failure meter reading for corresponding printer for the notification N.
outputting information.
